(19) United States
(12) Patent Application Publication
(10) Pub. No.: US 2002/0029358 A1
(43) Pub. Date: Mar. 7, 2002

(54) Method and apparatus for delivering error interrupts to a processor of a modular, multiprocessor system

(76) Inventors: Chester W. Pawlowski, Westford, MA (US); Stephen R. Van Doren, Northborough, MA (US); Barry A. Maskas, Sterling, MA (US)

Correspondence Address: CESARI AND MCKENNA, LLP, 88 BLACK FALCON AVENUE, BOSTON, MA, 02210, US

(21) Appl. No.: 09/867,138

(22) Filed: May 29, 2001

Related U.S. Application Data
(60) Provisional application No. 60/208,363, filed on May 31, 2000.

(51) Int. Cl. H04L 1/22

(52) U.S. Cl. 714/39

(57) ABSTRACT

A technique is provided for delivering error interrupts to a processor designated to service interrupts in a modular, multiprocessor system having a plurality of input/output port (IOP) interfaces distributed throughout the system. An error notification message is transmitted to a selected one of these IOP interfaces, each of which is capable of issuing transactions over a switch fabric of the system. The selected IOP converts the error notification message into a write transaction directed to an interrupt register of a local switch coupled to the designated processor. The write transaction is processed in connection with the contents of the interrupt register and a resulting signal is forwarded to logic circuitry of the local switch. The logic circuitry then translates the signal to an interrupt request signal that is provided to the designated processor.

### CROSS-REFERENCE TO RELATED APPLICATIONS

The present application claims priority from U.S. Provisional Patent Application Serial No. 60/208,363, which was filed on May 31, 2000, by Chester Pawlowski, Stephen Van Doren and Barry Maskas for a METHOD AND APPARATUS FOR DELIVERING ERROR INTERRUPTS TO A PROCESSOR OF A MODULAR, MULTIPROCESSOR SYSTEM and is hereby incorporated by reference.

### BACKGROUND OF THE INVENTION

1. Field of the Invention

The invention relates generally to computer systems and, in particular, to the delivery of error interrupts to a processor of a computer system.

2. Background Information

Error interrupt signals are typically generated by entities or “agents” of a computer system in response to the detection of errors by those agents, which may include processors, memory controllers or input/output (I/O) interface devices of the computer system. In a conventional bus-based computer system, the error interrupts may be manifested as interrupt signals that are asserted over the bus and provided to a single agent of the system, such as a processor, designated to service the interrupts. To ensure that only the processor designated to service the errors receives the interrupt signals, a control status register (CSR) located on each processor may be used to “mask out” the asserted signals if the processor is not designated to receive the signals. Alternatively, a semaphore, such as a lock variable, may be used to limit access to data structures employed to service the interrupts to only the designated processor.

In addition, restrictions may be placed on the configuration of the computer system to ensure that only the designated processor receives the interrupt signals. That is, a processor, such as a primary processor, may be designated to service all error interrupts detected in the system. In the absence of a primary processor, another processor may be designated to service the interrupts. For example, the processor closest to the agent generating the interrupt may be designated as the processor for servicing the interrupts. The designated processor may further be the first processor to receive the error interrupt signals, the processor issuing a reference in response to “seeing” the errors, or the processor that caused the errors.

In modular, multiprocessor computer systems, the processors may be distributed over physically remote subsystems that are interconnected by a switch fabric. These large systems may further be configured according to a distributed shared memory (DSM) or a non-uniform memory access (NUMA) paradigm. Error interrupts are preferably targeted to a specific processor, such as a primary processor, of the system to thereby avoid interrupting multiple processors for the same event. To that end, an operating system may be configured to interrupt only the primary processor of the system in response to an error event. A problem with this approach, however, is that the primary processor may be located anywhere within the distributed system. If system hardware is preconfigured to deliver the error interrupt to a particular processor location, transactions must be typically used to communicate with the other processors.

Furthermore, in a DSM or NUMA system that may be partitioned into a plurality of hard partitions of independent computer systems, there may be more than one primary processor. In this case, there must be a means for steering an error interrupt signal to the appropriate primary processor depending upon, e.g., which agent detected the error. The system may further be configured for high availability, which denotes that the agents of the system (including the processors) are “hot-swappable”. If it is desired to remove the primary processor and substitute its responsibilities with that of another primary processor in the system, a flexible means for redirecting error interrupts to the substituted primary processor is required. The present invention is directed to an error delivery technique that supports various system configurations and that leverages existing system resources to support error interrupt message delivery to any processor at any location in the system.

### SUMMARY OF THE INVENTION

The present invention relates to a technique for delivering error interrupts to a processor designated to service interrupts in a modular, multiprocessor system having a plurality of input/output port (IOP) interfaces distributed throughout the system. According to the error interrupt delivery technique, an error notification message is transmitted to a selected one of these IOP interfaces, each of which is capable of issuing transactions over a switch fabric of the system. The error notification message may originate from any entity or subsystem, including system management entities residing on their own communication network. The selected IOP converts the error notification message into a write transaction directed to an interrupt register of a local switch coupled to the designated processor. The write transaction is processed in connection with the contents of the interrupt register and a resulting interrupt request generation signal is forwarded to error interrupt array logic circuitry of the local switch. The array logic then translates the signal to an interrupt request signal that is provided to the designated processor.

In the illustrative embodiment, the designated processor is identified by an error interrupt target register in the IOP that may be programmed by system software or firmware to reference the designated processor at any location within the system. The error interrupt target register includes a plurality of fields, each of which may be configured to specify a type of error that is reportable to the designated processor. The interrupt register is also configured to specify the type of error interrupt that may be reported to the designated processor. The write transaction directed to the interrupt register is issued to the system as a register reference operation, subject to normal routing channel and flow control of the system. Through the use of error type masks, the occurrence of multiple error interrupts of the same type, but issued by different subsystems, can be detected.

Advantageously, the novel error interrupt delivery technique is fashioned in a flexible manner to enable error interrupt message delivery to any location in the system, regardless of the designated processor's relative “proximity” to the entity or subsystem issuing the error interrupt. The flexibility provided by the inventive delivery technique is needed because, e.g., the designated processor may be located anywhere within the multiprocessor system. That is, for a multiprocessor system configured as a NUMA system with processors interconnected by a switch fabric, the agents reporting errors may not be “local” to the processor designated to service the interrupts. Additionally, for a multiprocessor system having a plurality of partitions, a plurality of processors may be designated as receiving the error interrupts. The inventive delivery technique supports each of these system configurations.

### BRIEF DESCRIPTION OF THE DRAWINGS

The above and further advantages of the invention may be better understood by referring to the following description in conjunction with the accompanying drawings, in which like reference numbers indicate identical or functionally similar elements:

FIG. 1 is a schematic block diagram of a modular, symmetric multiprocessing (SMP) system having a plurality of Quad Building Block (QBB) nodes and an input/output (I/O) subsystem interconnected by a hierarchical switch (HS);

FIG. 2 is a schematic block diagram of a QBB node of FIG. 1;

FIG. 3 is a schematic block diagram of the I/O subsystem of FIG. 1;

FIG. 4 is a schematic block diagram of a console serial bus (CSB) subsystem within the SMP system;

FIG. 5 is a schematic block diagram of an error interrupt delivery arrangement in accordance with the present invention;

FIG. 6 is a schematic diagram showing a format of an error interrupt target register that may be advantageously used with the present invention;

FIG. 7 is a schematic block diagram of error interrupt array logic circuitry that may be advantageously used with the present invention;

FIG. 8 is an illustration of a processor interface defining types of error interrupts and their associated interrupt request levels supported by the SMP system;

FIG. 9 is a schematic block diagram of a format of a non-device interrupt register that may be advantageously used with the present invention; and

FIG. 10 is a schematic block diagram illustrating the interaction between the CSB subsystem and the QBB nodes coupled to the HS of the SMP system.

### DETAILED DESCRIPTION OF AN ILLUSTRATIVE EMBODIMENT

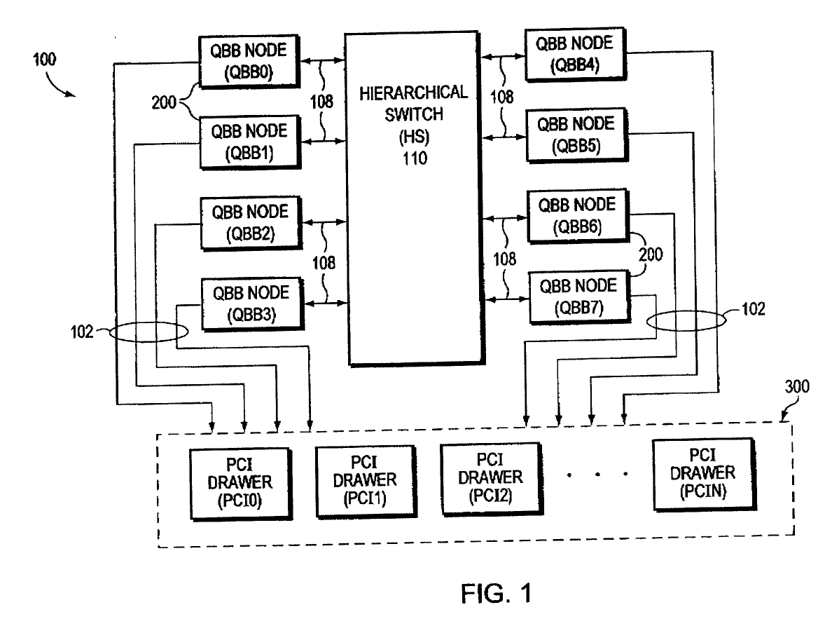

FIG. 1 is a schematic block diagram of a modular, symmetric multiprocessing (SMP) system 100 having a plurality of nodes 200 interconnected by a hierarchical switch (HS) 110. The SMP system further includes an input/output (I/O) subsystem 300 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, a directory, an I/O port (IOP), a plurality of I/O risers and a global port (GP) interconnected by a local switch. Each memory module may be shared among the processors of a node and, further, among the processors of other QBB nodes configured on the SMP system to create a distributed shared memory (DSM) or a non-uniform memory access (NUMA) environment. A fully configured SMP system preferably comprises eight (8) QBB (QBB0-7) nodes, each of which is coupled to the HS 110 by a full-duplex, bi-directional, clock forwarded HS link 108.

Data is transferred between the QBB nodes 200 of the system 100 in the form of packets. In order to provide a DSM or NUMA environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

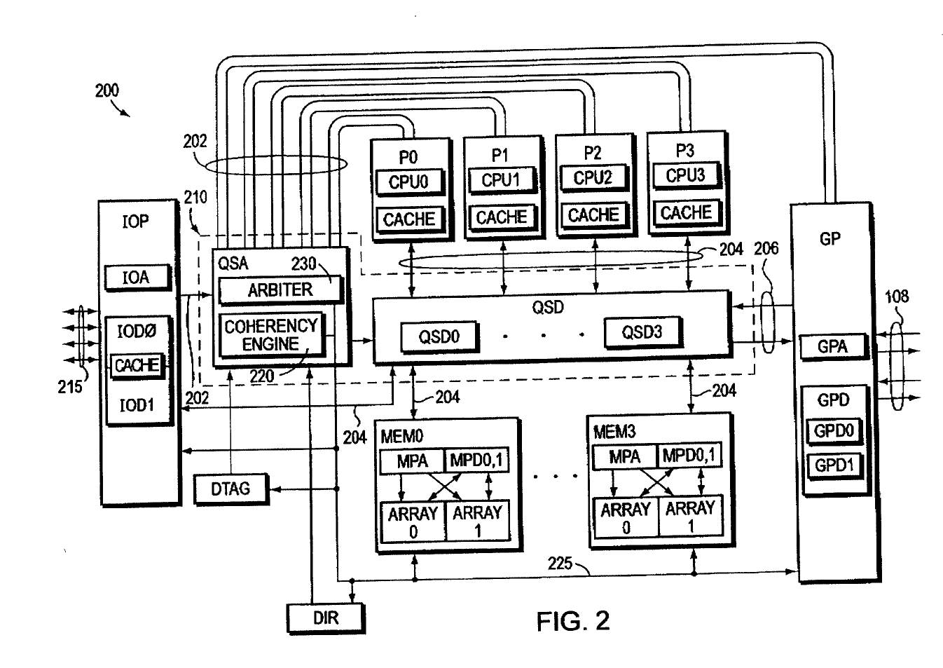

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node 200 in the form of packets. As used herein, the term “system” refers to all components of the QBB node excluding the processors and IOP.

Each processor is a modem processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, Houston, Tex., although other types of processor chips may be advantageously used. The load/store instructions executed by the processors are issued to the system as memory reference transactions, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be advantageously used. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and IOP via 14-bit, unidirectional links 202. The QSD, on the other hand, transmits and receives data to and from the processors, the IOP, the GP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects.

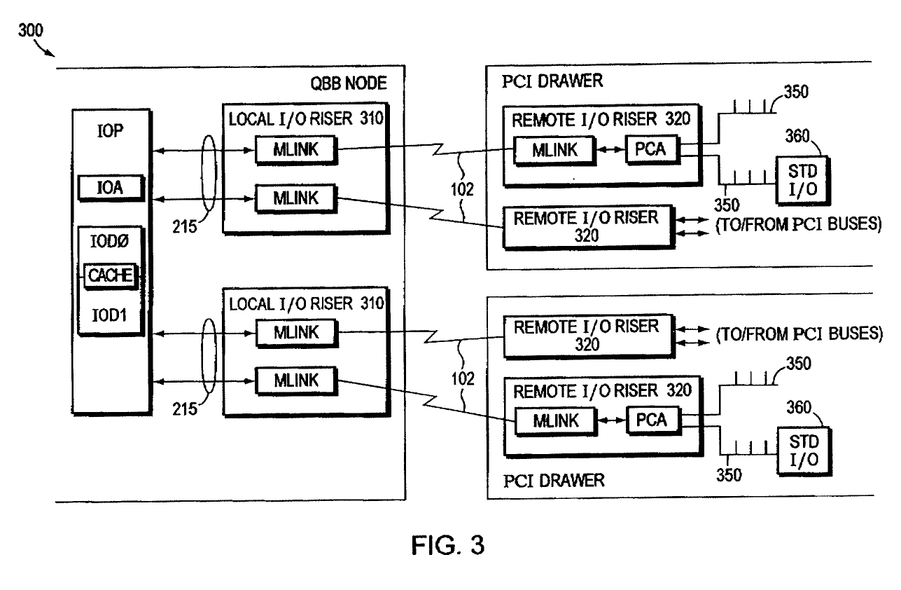

The IOP preferably comprises an I/O address (IOA) ASIC and a plurality of I/O data (IOD0-1) ASICs that collectively provide an I/O port interface from the I/O subsystem to the QBB node. The IOP is connected to a plurality of local I/O risers (FIG. 3) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS 110 via a set of unidirectional, clock forwarded address and data HS links 108.

A plurality of shared data structures are provided for capturing and maintaining status information corresponding to the states of data used by the nodes of the system. One of these structures is configured as a duplicate tag store (DTAG) that cooperates with the individual hardware caches of the system to define the coherence protocol states of data in the QBB node. The other structure is configured as a directory (DIR) to administer the distributed shared memory environment including the other QBB nodes in the system. Illustratively, the DTAG functions as a “short-cut” mechanism for commands at a “home” QBB node, while also operating as a refinement mechanism for the coarse protocol state stored in the DIR at “target” nodes in the system. The protocol states of the DTAG and DIR are managed by a coherency engine 220 of the QSA that interacts with these structures to maintain coherency of cache lines in the SMP system 100.

The DTAG, DIR, coherency engine, IOP, GP and memory modules are interconnected by a logical bus, hereinafter referred to as an Arb bus 225. Memory and I/O reference operations issued by the processors are routed by an arbiter 230 of the QSA over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used.

FIG. 3 is a schematic block diagram of the I/O subsystem 300 comprising a plurality of local and remote I/O risers 310, 320 interconnected by I/O hoses 102. The local I/O risers 310 are coupled directly to QBB backplanes of the QBB nodes 200, whereas the remote I/O risers 320 are contained within PCI drawers of the I/O subsystem. Each local I/O riser preferably includes two local Mini-Link copper hose interface (MLINK) ASICs that couple the I/O ports 215 to local ends of the I/O hoses. Each PCI drawer includes two remote I/O risers 320, each comprising one remote MLINK that connects to a far end of the I/O hose 102. The I/O hose comprises a “down-hose” path and an “up-hose” path to enable a full duplex, flow-controlled data path between the PCI drawer and IOP. The remote MLINK also couples to a PCI bus interface (PCA) ASIC that spawns two PCI buses 350, a first having three slots and a second having four slots for accommodating I/O devices, such as PCI adapters. The first slot of first PCI bus is preferably reserved for a standard I/O module 360.

The SMP system further includes a console serial bus (CSB) subsystem that manages reset functions and various power, cooling and clocking sequences of the subsystems within the SMP system in order to, inter alia, discharge system management functions directed to agents or field replaceable units (FRUs) of the system. In particular, the CSB subsystem is responsible for managing the configuration of agents within each QBB node and the power-up sequence of those elements, including the HS, handling “hot-swap” of the agents/FRUs, resetting FRUs and conveying relevant status and inventory information about the agents to designated processors of the SMP system.

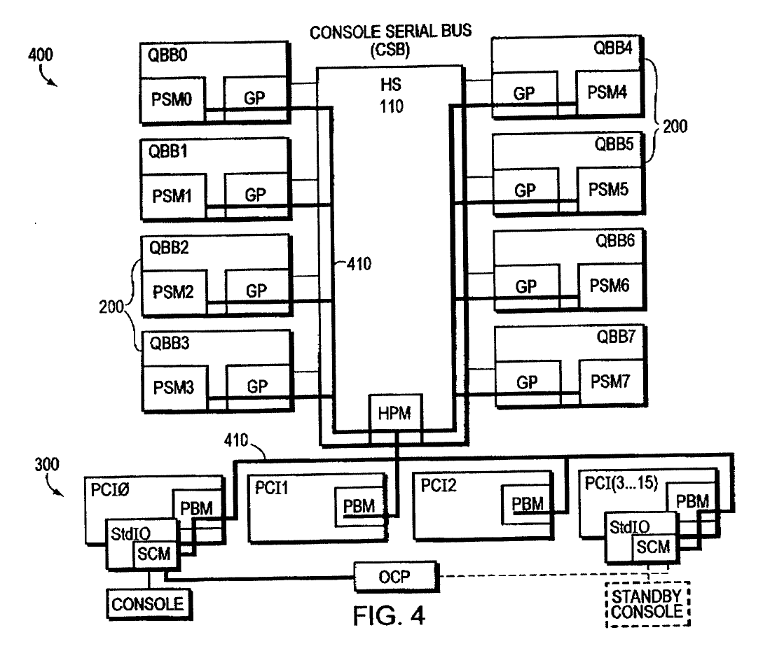

FIG. 4 is a schematic block diagram of the CSB subsystem 400 comprising a CSB bus 410 that extends throughout the SMP system interconnecting each QBB node 200 with the I/O subsystem 300. The CSB bus 410 is preferably a 4-wire interconnect linking a network of microcontrollers located within each PCI drawer and QBB node coupled to the HS 110 of the SMP system 100. The CSB subsystem operates on an auxiliary voltage (V-aux) supply to “bring-up” (power) the microcontrollers of the CSB subsystem to thereby enable communication over the CSB bus 410 in accordance with a serial protocol, an example of which is the transport protocol provided by Cimetrics, Inc. The microcontrollers are responsible for gathering and managing configuration information pertaining to each agent within each subsystem.

The microcontrollers preferably include a power system manager (PSM) residing on a QBB backplane of each node, a HS power manager (HPM) residing on the HS, a PCI backplane manager (PBM) coupled to the PCI backplane of each PCI drawer and at least one system control manager (SCM) of the I/O subsystem. Broadly stated, the SCM interacts with the various microcontrollers of the hardware subsystem 400 in accordance with a master/slave relationship over the CSB bus. For example, the “master” SCM may instruct the “slave” microcontrollers to monitor their respective subsystems to retrieve status information pertaining to the agents in order to facilitate system management functions.

The PSM is a microprocessor controlled sub-system that is responsible for power management, environmental monitoring, asynchronous reset and initialize, inter-IC Bus management, CPU Serial I/O communication, and CSB communication for each QBB. The PSM receives real-time operational commands via a constituent CSB interface. The PSM preferably includes three management buses, such as the inter-IC or IIC (hereinafter “I²C”) bus available from Signetics/Phillips Corporation, each having a master device that controls the bus, and which is programmed during PSM Initialization. Bus_01 in the QBB connects to all four CPU module slots and all four memory module slots on the backplane. Bus_02 in the QBB connects to four I/O Riser module slots, the Directory module slot, the GP module slot, and the +3.3V DC Converter module slots. Bus_03 is shared between component devices mounted on the QBB backplane, and the PSM itself. The PSM may also contain an EEPROM, and three LM80 devices for monitoring various analog and digital signals. All three buses preferably operate at a nominal 90K bits/second.

The PSM, PBM and HPM monitor a variety of environmental and system operational conditions, such as system and/or component temperature levels, fan operation, etc. In response to these conditions exceeding or falling below predefined limits and/or thresholds, the PSM, PBM and HPM may issue system event interrupts.

The PSM has a two-tier design for Asynchronous Reset control within the QBB, which is preferably structured as the entire QBB (backplane inclusive) or an individual module function. Whenever a QBB-level reset command is implemented, the QBB asynchronous reset signal, e.g., QBB_ASYN_RESET_L, and all module asynchronous reset signals, e.g., Module(x)_ASYN_RESET_L, are driven simultaneously. The PSM may also support individual control of a Module(x)_ASYN_RESET_L signal to most optionmodules, which allows fully independent control of the module. These modules include: the CPU's, Memories, I/O Risers, the Directory, and the GP. A Discrete Reset Control Register is used to assert/deassert the individual Module(x)_ASYN_RESET_L signals to these modules.

The asynchronous reset logic on the PSM controls the asynchronous reset signal to the QBB, signal QBB_ASYN_RESET_L, and the individual module asynchronous reset signals Module(x) ASYN_RESET_L. When power is off to the QBB, and during the QBB Power_On process, these reset signals are all asserted, and are only deasserted after all power-on conditions have been met. These same signals are also “pulsed” to implement the CSB command “QBB Pulsed_Reset”, which is generated via the switch on the OCP module. During normal operation, each of the Module(x)_ASYN_RESET_L signals in the QBB (one to each module), can be independently controlled via the Discrete Reset Control Registers, and can be used to place a module into a static quiescent state if necessary by the operating system.

The PSM can issue both a “pulsed” async reset condition, or a static async reset condition held indefinitely, to the entire QBB. The “pulsed” condition for example, would be issued in response to a CSB command “QBB Pulsed_Reset”, to which, the PSM will simultaneously pulse a QBB_ASYN_RESET_L signal and all Module(X)_ASYN_RESET_L signals in the QBB, via the assertion and deassertion of a microprocessor signal MP_CMD_RESET. The “static” reset condition is preferably asserted in response to the CSB command “QBB Reset_On”. The static reset condition may also be asserted whenever QBB power is off, automatically by the PSM. If asserted by the CSB command, the condition is held asserted until the deassertion command “QBB Reset_Off” is received. During normal operation, previous to implementing the command for either the pulsed or static reset condition, a 3 milli-second advance notification System Event code is preferably issued to the QBB.

The signals QBB_ASYN_RESET_L and Module (X)_ASYN_RESET_L are all initially asserted during PSM Reset and remain asserted to the QBB until the QBB Power_On process allows their deassertion. The signals also will automatically be asserted by fixed hardware whenever there is a Bulk DC power failure in the QBB. During the power-off process, by either CSB command or by an AC/DC power failure, the signals QBB_ASYN_RESET_L and Module(x)_ASYN_RESET_L to the QBB, all become asserted. Additionally, the signal MP_CMD_RESET is preferably asserted immediately following the Deassertion of the MP_48VDC_ENABLE_L signal.

Furthermore, most modules in the QBB have an asynchronous reset signal, each of which can be independently controlled at the PSM preferably via the “Discrete Reset Control (DRC) Registers”. There are two registers used for this function: DRC Reg_1 and DRC Reg_2. Both use the chip select signal “PCS6” as the interface enable, and both have fully independent set/clear control of each register bit, which has been assigned a specific address within the “PCS6” I/O Space. The registers may be an inherent part of the QBB Power_On process, and may also be used during normal operation to assert/deassert the asynchronous reset signal to an individual module. All register outputs are initially asserted during PSM Reset, and will also become asserted by the fixed hardware logic whenever a power-off or power failure is initiated. Also, during normal operation, any CPU or I/O Riser module that exhibits a power failure will have its Module(x)_ASYN_RESET_L signal asserted by the respective signal bit at the DRC Register. The signal Module(x)_ASYN_RESET_L can also be asserted at any time by the SCM master to quiescent any module logically if needed.

During normal operation, any CPU or I/O Riser module can also have its corresponding Module(x)_ASYN_RESET_L signal asserted/deasserted as necessary by the PSM preferably by setting or clearing the target module's corresponding “ASYNC_RESET” bit at DRC Reg_1 or DRC Reg_2.

As part of its management functions, the SCM provides an operator command line interface (CLI) on local and modem ports of the system, while monitoring operator control panel (OCP) switches/buttons and displaying system state information on the OCP. The SCM further provides remote system management functions including system-level environmental monitoring operations and, e.g., power on/off, reset, halt, fault functions associated with the OCP. In addition, the SCM interfaces with a system reference manual (SRM) console application executing on a system processor of a QBB node. The SCM preferably resides on the standard I/O module within a PCI backplane and provides a communication port for the SRM console.

The SRM console operates at a command-level syntax to provide system management functions (such as boot, start-up and shutdown functions). Operating system calls are issued to the SRM console and manifested through a data structure arrangement to enable communication with the SCM. In the illustrative embodiment, the SRM console software interfaces with the CSB hardware subsystem 400 through the SCM and, in particular, through a configuration port of a dual-ported, shared random access memory (RAM) to convey status information to an operating system executing on the processor. The configuration port appears in the address spaces of both the SCM microcontroller and the system processor. The shared RAM allows both entities to efficiently communicate configuration changes by manipulating data structures stored in the shared RAM.

As noted, the SMP system 100 may be configured as a DSM or NUMA environment with processors distributed over physically remote subsystems or nodes that are interconnected by a switch fabric. Error interrupts are preferably targeted to a designated processor of the system to thereby avoid interrupting multiple processors for the same event. To that end, the operating system may be configured to interrupt only the designated processor of the system in response to an error event. A problem with this approach, however, is that the designated processor may be located anywhere within the distributed system. The system hardware thus cannot be preconfigured to deliver the error interrupt to a particular location because the processor at that location may not be the processor designated to service interrupts in the system.

Agents that can detect and generate errors include memory modules, PSM, GP, QSA, Directory (DIR), Duplicate Tag (DTAG), IOP, processors and QSD. The following table illustrates the error status pins utilized to collect errors from the agents.

| Pin Group | Pin Name (backplane) | Pin Name (hswitch) |
|---|---|---|
| PSM | qbb_dc_good | hs_dc_good |
| | qbbp1_int_1 | hsp1_int_1 |
| | qbb_icl[4:0] | hs_icl[4:0] |
| | qbb_async_reset_1 | hs_async_reset_1 |
| reserved | psm_fault_mask_1 | psm_fault_mask_1 |
| mode | | |
| reserved | fault_tosys_event_1 | cable0_1in_1 |
| mode | | |
| CPU0 | cpu0_dcok | UNUSED |
| | cpu0_present_1 | qbb0_valid |
| | cpu0_buf_srom_enb | UNUSED |
| CPU1 | cpu1_dcok | UNUSED |
| | cpu1_present_1 | qbb1_valid |
| | cpu1_buf_srom_enb | UNUSED |
| CPU2 | cpu2_dcok | UNUSED |
| | cpu2_present_1 | qbb2_valid |
| | cpu2_buf_srom_enb | UNUSED |
| CPU3 | cpu3_dcok | UNUSED |
| | cpu3_present_1 | qbb3_valid |
| | cpu3_buf_srom_enb | UNUSED |
| MEM0 | mem0_present_1 | qbb4_valid |
| | mem0_error_status[1:0] | hsd0_error_status |
| MEM1 | mem1_present_1 | qbb5_valid |
| | mem1_error_status[1:0] | hsd2_error_status |
| MEM2 | mem2_present_1 | qbb6_valid |
| | mem2_error_status[1:0] | UNUSED |
| MEM3 | mem3_present_1 | qbb7_valid |
| | mem3_error_status[1:0] | UNUSED |
| GP | gp_present_1 | cable0_2in_1 |
| | hs_gp_valid | cable0_3in_1 |
| | qbb_valid | cable1_1in_1 |
| | gp_error_status[1:0] | UNUSED |
| | hs_present_1 | cable1_2in_1 |
| QSD | gp_valid | cable1_3in_1 |
| | qsd[3:0]_error_status | UNUSED |
| | qsd[3:0]_fault_reset_1 | cable2_1in_1 - cable3_1in_1 |
| QSA | cfi_cmd_on_arb | UNUSED |
| | qsa_async_reset_1 | cable3_2in_1 |
| | qsa_error_status[1:0] | UNUSED |
| DTag | dtag[7:0]_error_status | UNUSED |
| | dtags4or8 | cable3_3in_1 |
| Directory | directory_present_1 | cable4_1in_1 |
| | dir_error_status[1:0] | UNUSED |
| IOP | ioa_async_reset_1 | cable4_2in_1 |
| | iod0_async_reset_1 | cable4_3in_1 |
| | iod1_async_reset_1 | cable5_1in_1 |
| | iop_error_status[1:0] | UNUSED |
| | io_riser[3:0]_present_1 | cable5_2in_1 - cable6_2in_1 |
| | ior[3:0]_dcok | cable6_3in_1 - cable7_3in_1 |

In the illustrative embodiment described herein, each QBB node of the SMP system initially operates independently until the local and hierarchical switches are initialized, which occurs during a power-up sequence. In such a system, election of a primary processor is needed to, inter alia, initialize appropriate hardware agents during the power-up sequence. An example of a technique for electing a primary processor within a multiprocessor computer system that may be advantageously used with the present invention is described in copending and commonly-owned U.S. patent application Ser. No. 09/546,340, filed Apr. 7, 2000, titled Mechanism for Primary Processor Election in a Distributed Modular Shared Memory Multiprocessor System Using Management Subsystem Service Processor, which application is hereby incorporated by reference as though fully set forth herein.

In accordance with the present invention, a technique is provided for delivering error interrupts to a designated processor, such as an elected primary processor, from among a plurality of processors interconnected by a switch fabric of the SMP system. Since the IOP is configured to initiate packets, all error events generated within a given QBB are preferably multiplexed or funneled to the local IOP. The IOPs can then forward these error events to a primary processor through system transactions or packets for servicing. At each QBB, however, there are 16 agents or sources of errors (four QSDs, four MPAs, four DTAGs, the GPA, the DIR, the QSA and the PSM). With prior art techniques one or more dedicated pins would be provided on the IOP to receive these interrupts. Rather than provide all these pins and the corresponding complexity to the system, the present invention provides an error delivery arrangement that collects errors from the agents, and forwards them to the IOP through a serial bit stream whose contents vary depending on the error type. All bit streams begin with an “error type” field, which is followed by an “entity” field indicating which agent sourced the error event, except for system event errors, where the “entity” field is replaced with a “system event type” field specifying the specific system event being reported as all system events originate from the PSM.

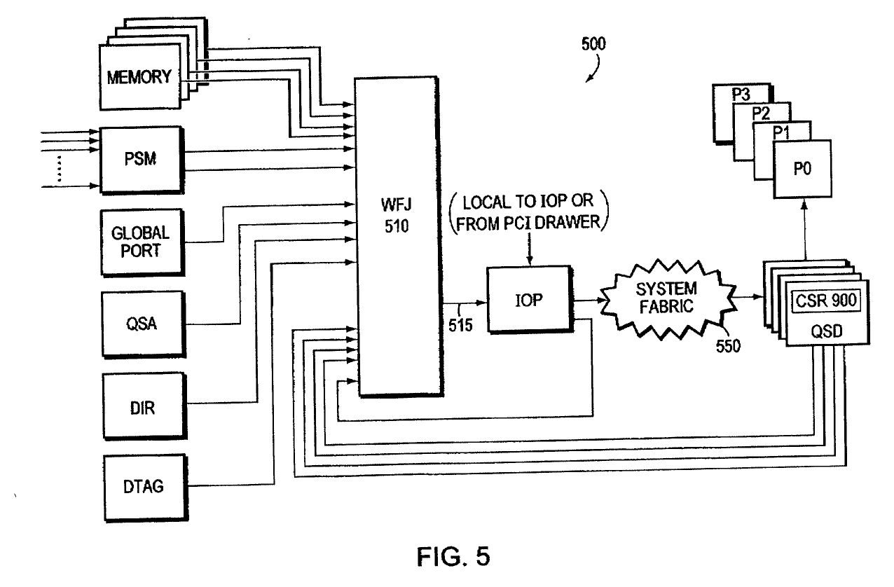

FIG. 5 is a schematic block diagram of an error interrupt delivery arrangement 500. In general, agents of the SMP system can detect and report an error event by asserting an interrupt signal over a wire connected to a special “junk” (WFJ) device 510 located on, e.g., a QBB backplane. The WFJ device functions as an intermediary that collects information, such as error interrupt signals, from various agents of the QBB node and forwards them onto other agents, such as the IOP, of the node.

Up to three different types of errors can preferably be asserted by each agent (excluding the PSM): fault interrupt, uncorrectable error interrupt, and correctable error interrupt. In parallel, the WFJ will decode the error status bit(s) from each entity and maintain up to three flag bits, F(atal), U(ncorrectable), and C(orrectable) for each. Each time a new error is decoded, the appropriate flag is set for that particular entity. Whenever a flag is set, the WFJ will set one of four pending registers indicating the type of error which is pending transmission. The pending errors are prioritized as follows with 1 being the highest priority: (1) Fatal, (2) System Event, (3) Uncorrectable, (4) Correctable. The WFJ will then traverse through the agents or entities in a round robin scheme, transmitting an error from each device having an error flag set that matches the highest priority currently pending. This process is repeated as long as errors are pending. To aid in fairness, the starting device number may be incremented with each pass through the list.

This scheme guarantees that no incoming errors should be lost except for repeated errors of the same type from the same device within a short duration (tens of frame clocks). This is of less concern as long as the first error of its type from a device is recorded; hence no missed error information is required to be kept.

System events from the PSM should be given a priority below fatal errors but above uncorrectables. When the special IF code is received from the PSM, indicating a system initiated fault reset, the normal fault reset procedure is preferably followed by the WFJ, with this code being transmitted to the IOP.

In the illustrative embodiment described herein, the WFJ device closest to the agent that detects an error receives the interrupt signal reported by that agent and issues an error notification message to the IOP located on its QBB node. In other words, the error interrupt signal is forwarded to the WFJ 510 located within the “home” QBB node 200 of the agent detecting the error. Uncorrectable and correctable errors, but not faults, detected locally within the IOP and remotely within PCI drawers (PCI devices and M-link ASICs), however, are fed directly to the IOA without passing through the WFJ device.

As indicated above, upon collecting error interrupts from agents on its local QBB node, the WFJ device 510 examines the interrupts to determine the most serious type from among the reported signals. Again, the most serious type of error interrupt is a fault interrupt, followed by an uncorrectable error interrupt and a correctable error interrupt. In addition, the PSM searches for system events, prioritizes them and serializes them to the WFJ device 510. These events are not errors but are merely notification events, such as a power supply exceeding regulation event or a fan failing to spin at the correct speed.

In response to examination of the collected error interrupt signals, the WFJ device implements a serial priority encoding technique to notify the IOP as to the type of error interrupt it received. That is, a state machine within the WFJ device encodes the type of error interrupt reported, along with the agent reporting the interrupt, as a serial chain, error notification message and forwards the message over line 515 to the IOP. The IOA of the IOP then analyzes the error notification message to determine the type (e.g., device, error or system event) of reported error. The encoding scheme enables the IOP to log the type of error interrupt into one or more IOA registers in order to facilitate servicing of that error by appropriate software executing on the system.

For example, an IOP QBB error summary (IOP_QBB_ERR_SUMM) register may be provided having one bit per error source per error type, which is set in response to received correctable or uncorrectable error bit streams. An IOP QBB system event summary (IOP_QBB_SE_SUM) register may be provided having a bit mask of system event types, which is sent in response to received system event bit streams. In response to a correctable, uncorrectable or system event serial stream, the IOP preferably sets one of three pending flags, i.e., one for each of correctable, uncorrectable and system events. The setting of these flags indicates to a special logic function in the IOA that an interrupt transaction is required. In response, the IOA preferably transmits a write command to a QSD non-device interrupt (QSD_NDI) register. A single write command can contain up to three interrupts of different types. The particular QSD_NDI register that is targeted by the write command is preferably determined by the contents of an IOP error interrupt target register, as described below.

The summary and NDI registers may be implemented as an array of bits where each NDI write command or transaction may write up to 1 bit in each of the three summary “registers”. The ID of the QBB node sourcing the NDI write command is preferably used to determine which bits in the summary “registers” are set. For example, if QBB5 issues the NDI write command, the write can modify the fifth bit in each of the summary “registers”. In this way, an IOP can report on more than one error at a time, and yet the reported errors can be organized by type rather than QBB ID.

The IOA then “steers” the interrupt, as manifested by a write transaction, over a system fabric 550 to a QSD of a local switch 210 coupled to the designated primary processor configured to service the interrupt. According to an aspect of the present invention, the IOA directs the write transaction to a predetermined control status register (CSR) in order to access resources of the primary processor needed to service the interrupt. That is, the IOA converts the error notification message received from the WFJ 510 into a register reference operation that is forwarded over the system fabric 550 to a CSR 900 located within the QSD associated with the primary processor. The system fabric 550 may comprise a “local fabric” involving the local switch 210 of a QBB node 200 and/or a “global fabric” extending through the GP of a node to the HS 110. In either case, the CSR write transaction propagates over the system fabric within the normal flow of transactions, subject to routing channel and flow control mechanisms of the SMP system 100.

For a SMP system having multiple IOPs, each CSR write transaction issued by an IOP may be steered towards the same target processor. Each IOP has a software-programmed CSR located in the IOA that is configured at the time the target processor (e.g., the primary processor) is elected and that specifies the primary processor as the target for receiving error interrupts steered from the IOP through the SMP system. In particular, the software servicing the error (i) determines which IOP in the system reported the error, (ii) examines an internal register of the IOP to determine the entity on whose behalf the IOP is reporting and (iii) interrogates that entity to determine the type of error. This information may be organized as a parsing tree for use in error handling within the SMP system.

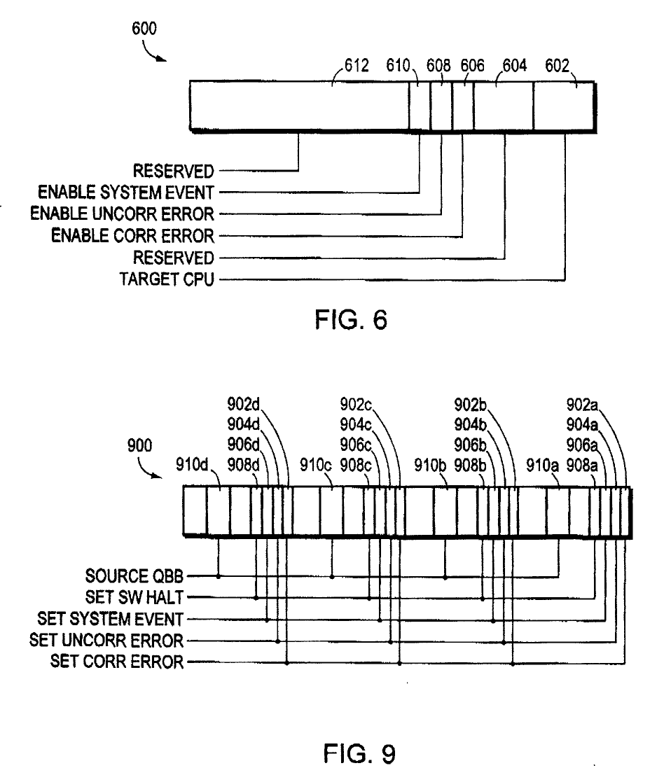

FIG. 6 is a schematic diagram showing the format of the software-programmed CSR, which is preferably an IOP error interrupt target (IOP_EIT) register 600. The console software operating on the primary processor performs a CSR write operation to the IOP_EIT register 600 to initialize and configure various fields of the register.

In the illustrative embodiment, the IOP_EIT register 600 comprises a target CPU field 602, an enable correctable error field 606, an enable uncorrectable error field 608 and an enable system event field 610. The console system software configures each of these fields to specify the type of errors/events that are reportable to the target processor. For example, the console may configure the target CPU field 602 to direct error interrupts to itself (i.e., the primary processor). Here, a 3-bit portion of the target CPU field 602 is used to specify the QBB node of the target (primary) processor, while a 2-bit portion of the field 602 identifies the CPU/processor within the specified QBB node. The console software may also assert respective bits within the 1-bit fields 606-610 to disable reporting of various types of error interrupts to the primary processor. That is, the console may assert a bit of the enable correctable error field 606 which, as described below, instructs the IOP not to issue a CSR write command to a QSD non-device interrupt (QSD_NDI) register 900 (FIG. 9) for correctable errors.

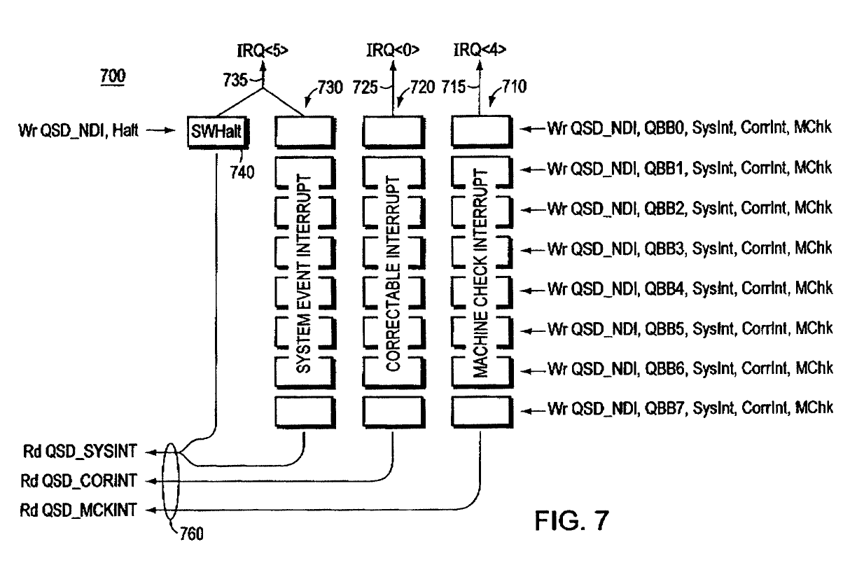

FIG. 7 is a schematic block diagram of error interrupt array logic circuitry 700 located in the QSD ASIC locally coupled to the primary processor. As described herein, an interrupt request generation signal is received “broadside” into a buffer array comprising a machine check interrupt buffer 710, a correctable interrupt buffer 720 and a system event interrupt buffer 730. The location of the interrupt generation signal within the buffers is dependent upon the source entity (QBBx) originating the error interrupt. Thus, any of eight QBB nodes 200 can report an error interrupt to a primary processor, wherein each of the QBB nodes is identified by the assertion of a bit within the corresponding location of the buffer. Depending upon the type of interrupt request generation signal (i.e., the severity of the error being reported), the bit is asserted in one of the interrupt buffers 710, 720, 730. Assertion of the bit, in turn, causes the assertion of a corresponding interrupt request level (IRQ) signal 715, 725, 735 conforming to a defined processor/CPU interface of the primary processor.

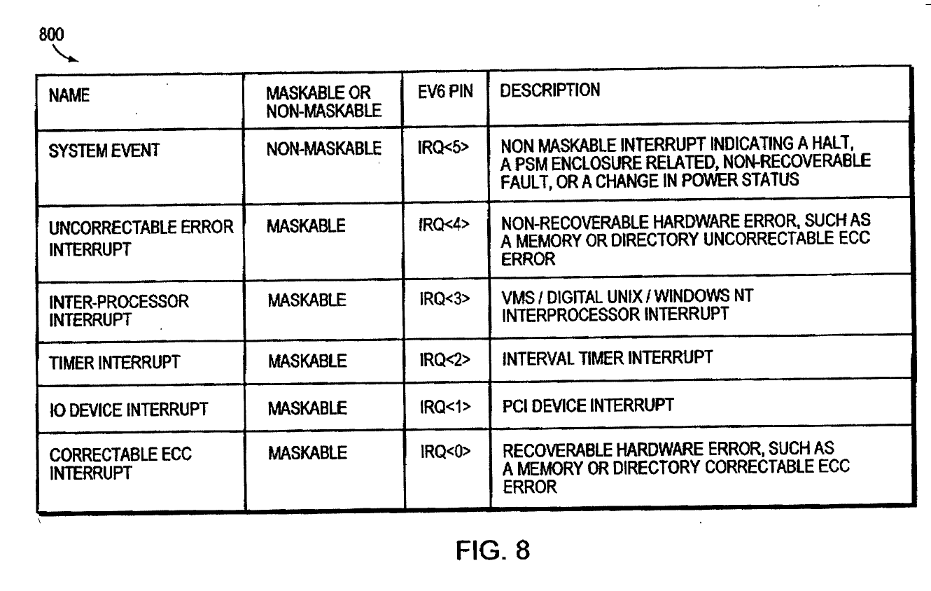

FIG. 8 is an illustration of a processor/CPU interface 800 defining the types of error interrupts and their associated IRQs supported by the SMP system 100. Each processor/CPU of the SMP system has an interface comprising a set of pins used to assert various interrupts. Error events that occur throughout the SMP system are reported in accordance with the set of interrupt pins representing various IRQs defined by the interface. Thus, the interface defines a mapping between various error events that generate the interrupt types and the set of pins corresponding to the IRQs. In response to an asserted IRQ signal, the primary processor retrieves the contents of the appropriate FIFO, e.g., 710, 720 or 730, over a corresponding line 760 (FIG. 7) to determine which IOP (i.e., QBB) reported the error interrupt and then clears the asserted bit in the FIFO.

Referring again to FIG. 7, a software halt may be employed to assert IRQ <5> and report a system event to the designated (primary) processor via the logic circuitry 700. A software halt essentially stops a processor and may be effected by, e.g., a user depressing a halt button on the OCP of the SMP system. In response to the detecting the software halt, a bit in the system event interrupt buffer 730 is asserted, thereby asserting the IRQ <5> signal 735 to the primary processor. A processor may also halt another processor by issuing a write operation to a CSR address; this results in the assertion of a bit within a SW Halt block 740 of the logic circuitry. The signals 760 emanating from the buffers are used by the primary processor to retrieve the contents of the buffers, thereby clearing any asserted bits in response to the asserted IRQ signals.

The interrupt request generation signals received at the logic circuitry 700 are originally issued by the IOPs of the QBB nodes over the HS 110 to the QSD that is “locally” coupled to the primary processor. The reception of an error interrupt signal at an IOP causes the IOP to generate a CSR write transaction to a QSD non-device interrupt (QSD_NDI) register 900 (FIG. 9) of the local QSD, subject to error enable (disable) bits in the IOP_EIT register 600. Preferably, each CSR write transaction is processed at the QSD as an Arb bus component identifying the write address of the CSR and a write data component containing the data. The data component is provided from the GPD ASIC to the QSD and a corresponding front-end/back-end set of commands are provided from the QSA to the QSD instructing the QSD where to forward the data.

FIG. 9 is a schematic block diagram of the format of the QSD_NDI register 900 that is contained within the QSD ASIC coupled to the (primary) processor designated to service the interrupt. The QSD_NDI register 900 comprises a bit location for each type of error interrupt that may be reported by an IOP. The IOP selects the QSD_NDI register 900 by means of the content of the target CPU field 602 of the IOP_EIT register 600 and formulates the QSD_NDI write data according to the type of error “flagged” (asserted) in the IOP_EIT register 600.

Specifically, the IOP generates a bit mask comprising assertion of one or more of a set system event bits 906, a set correctable error bits 902 and/or a set uncorrectable error 904 bits of the QSD_NDI register 900 to specify the type of error it wishes to report. The IOP does not, however, assert the set software (SW) halt bit 908. When the CSR write transaction arrives at the QSD, it is processed in connection with the contents of register 900 to produce the interrupt request generation signal. That is, the IOP is identified within the write transaction by a source QBB number that is compared with the contents of the source QBB fields 910a-d of the register 900. Upon realizing a match, the write data component of the transaction is decoded and logically combined (e.g., ANDed) with the appropriate bit mask within the QSD NDI register to produce the interrupt request generation signal that asserts a bit within the appropriate column of the array logic 700.

While there has been shown and described illustrative embodiments for delivering error interrupts to a designated processor from among a plurality of processors interconnected by a switch fabric of a SMP system, it is to be understood that various other adaptations and modifications may be made within the spirit and scope of the invention. For example, the DSM or NUMA system may be partitioned into a plurality of hard partitions of independent computer systems, each of which may have a primary processor designated to, inter alia, service error interrupts detected within its partition. Thus, in an alternate embodiment, the QBB nodes may be organized into hard partitions and the CSB subsystem provides a means for communicating among those hard partitions.

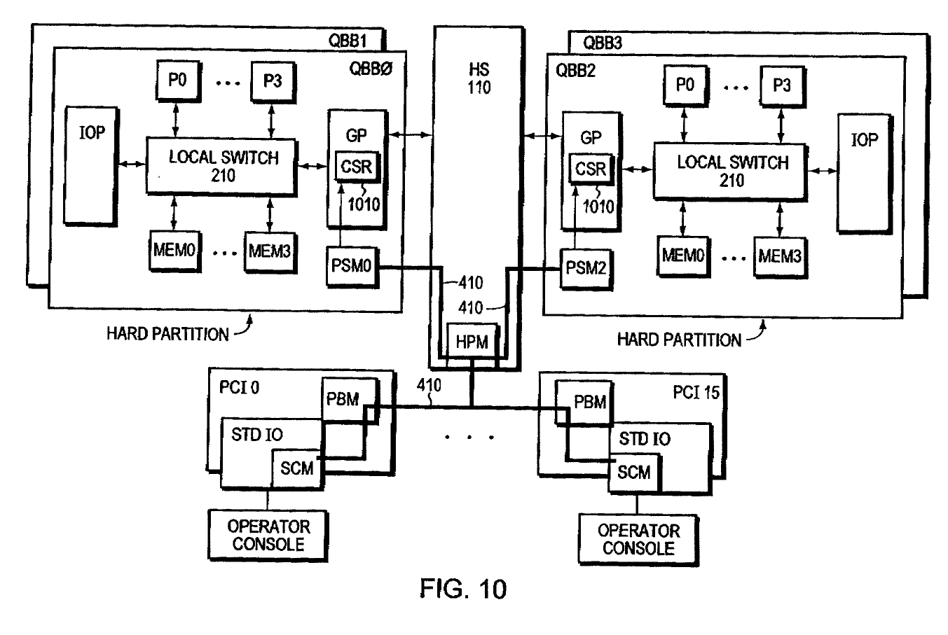

FIG. 10 is a schematic block diagram illustrating the interaction between the CSB subsystem and the QBB nodes organized as hard partitions coupled to the HS of the SMP system. A hard partition comprises a group of hardware resources (processors, memory and I/O) that is organized as an address space having an instance of an operating system executing thereon. The hardware resources within a hard partition are preferably defined and organized according to configuration information provided by the CSB subsystem. However, the CSB subsystem has an address space that is generally independent of the address spaces of the processors of the partitions. The CSB subsystem thus communicates with each partition through the configuration port that is accessible by the SCM microcontroller and system processors.

Moreover, each hard partition has an address space that is separate and independent from other hard partitions such that there is no sharing of resources or data items among the partitions. To that end, each partition comprises a “firewall” that is established by configuring certain CSRs 1010 located in the GP of a QBB node. These configuration registers allow the SMP system to be partitioned in a “hard” manner as defined by an operator of the CSB subsystem. An example of a technique for defining and maintaining partitions in a modular computer system that may be advantageously used with the present invention is described in copending and commonly-owned U.S. patent application Ser. No. 09/545,781, filed Apr. 7, 2000, titled Facility for Managing Hard and Soft Partitions Via Replicated Configuration Trees Maintained By A Management Subsystem, which application is hereby incorporated by reference as though fully set forth herein.

In such a partitioned system, the various IOPs may send their interrupts to different primary processors, depending upon the partitions to which they are assigned. As described above, the target CPU field 602 of the IOP_EIT register 600 located in each IOP may be programmed to specify the particular processor designated to receive error interrupts for each hard partition in the SMP system. The novel error interrupt delivery mechanism thus provides a flexible technique that supports various system configurations, while enabling interrupt message delivery to any processor at any location in the system.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for delivering an error interrupt to a processor designated to service interrupts in a multiprocessor system having a plurality of nodes coupled to a switch fabric of the system, the method comprising the steps of:
multiplexing a plurality of error event signals generated in a given node of the system;
forwarding the multiplexed error event signals as a serial bit stream to an input/output port (IOP) of the given node; and
converting the multiplexed error event signals from the serial bit stream into one or more write transactions directed to an interrupt register associated with the designated processor.

2. The method of claim 1 further comprising the steps of:
providing one or more error summary registers, the error summary registers having fields associated with each node of the system;
in response to the one or more write transactions directed to the interrupt register, writing to the fields of the one or more summary registers associated with the given node.

3. The method of claim 2 further comprising the steps of:
asserting one or more level sensitive interrupt (LSI) lines of the designated processor, in response to the step of writing to the one or more summary registers.

4. The method of claim 3 further comprising the steps of:
processing the write transaction in connection with contents of the interrupt register to produce an interrupt request generation signal;
forwarding the interrupt request generation signal to error interrupt array logic of the local switch; and
translating the interrupt request generation signal to an interrupt request signal for use by the designated processor in servicing the error interrupt.

5. The method of claim 4 further comprising the steps of:
detecting an error event at an agent of a home node in the multiprocessor system;
reporting the error event to an intermediary device coupled to the home node; and
encoding the error event at the intermediary device as the error notification message.

6. The method of claim 5 wherein the step of reporting comprises the steps of:
asserting an error interrupt signal over a wire connected to the intermediary device; and
examining the error interrupt signal at the intermediary device to determine the type of error reported by the agent.

7. The method of claim 6 wherein the step of encoding comprises the step of encoding the type of reported error event and the agent reporting the event as a serial chain message.

8. The method of claim 1 wherein the step of converting comprises the steps of:
analyzing the error notification message at the selected IOP to determine the type of reported error;
logging the type of reported error to facilitate servicing of that error by software executing on the system; and
steering the write transaction over the system fabric to the interrupt register.

9. The method of claim 8 wherein the step of steering comprises the step of forwarding the write transaction to a designated processor location specified by a programmable control status register in the IOP.

10. The method of claim 1 wherein the step of processing comprises the steps of:
comparing a source node number of the write transaction with contents of source node fields of the interrupt register;
s if there is a match, decoding a data component of the write transaction; and
logically combining the decoded data component with an appropriate bit mask of the interrupt register to produce the interrupt request generation signal.

11. The method of claim 10 wherein the step of translating the interrupt request generation signal comprises the steps of:
receiving the interrupt request generation signal at array logic comprising a plurality of first-in, first-out (FIFO) buffers;
depending upon a type of interrupt request generation signal, asserting a bit within an appropriate one of the plurality of FIFO buffers; and
asserting the interrupt request signal corresponding to the asserted bit, the interrupt request signal conforming to a defined interface of the designated processor.

12. The method of claim 1 wherein the multiprocessor system is partitioned into a plurality of hard partitions and wherein the step of transmitting an error notification message comprises the step of transmitting an error notification message to a selected input/output port (IOP) of the hard partition.

13. A multiprocessor computer system having a plurality of nodes coupled to a switch fabric, each node having one or more processors, at least one processor of the system being designated to service interrupts, the system comprising:
an interrupt register associated with the designated processor;
two or more input/output ports (IOP) each having receiver circuitry for receiving an error notification message that corresponds to an interrupt, and conversion circuitry for converting the error notification message into a write transaction directed to the interrupt register; and
a signal generator configured to produce an interrupt request generation signal in response to both the write transaction and the contents of the interrupt register, wherein
the interrupt request generation signal triggers the designated processor to service the interrupt corresponding to the error notification message.

14. The multiprocessor computer system of claim 13 further comprising error interrupt array logic circuitry, the array logic circuitry configured to receive the interrupt request generation signals and, in response, to assert corresponding interrupt request level (IRQ) signals to the designated processor.

15. The multiprocessor computer system of claim 14 wherein,
the array logic circuitry has a plurality of first-in-first-out (FIFO) buffers configured to store an identifier of the IOP originating a write transaction, and
in response to the assertion of the interrupt request level (IRQ) signal to the designated processor, the processor retrieves the contents at the head of the FIFO corresponding to the asserted IRQ signal so as to determine which IOP originated the respective write transaction.

16. The multiprocessor computer system of claim 15 wherein
the interrupts are non-device interrupts and they include system event interrupt types, correctable interrupt types and machine check interrupt types,
the FIFOs of the array logic circuitry are organized into sets by interrupt types, and
each FIFO set is associated with a corresponding IRQ signal that is asserted in response to receipt of an interrupt request generation signal corresponding to the FIFO's respective interrupt type.

17. The multiprocessor computer system of claim 13 wherein the computer system has a plurality of agents configured to assert error interrupt signals in response to the detection of an error, and the computer system further comprises an interrupt collecting device in communicating relationship with an IOP, the interrupt collecting device configured to receive the error interrupt signals asserted by the agents, and encode the error interrupt signals into the error notification messages for transmission to the IOP.

18. The multiprocessor computer system of claim 17 wherein
the agents can assert fatal, system event, uncorrectable and correctable error interrupt signal types, and
the interrupt collecting device is configured such that each error notification message identifies the interrupt type and the agent that asserted the respective interrupt signal.

19. The multiprocessor computer system of claim 18 wherein the interrupt collecting device prioritizes the transmission of error notification messages to the IOP based on the type of interrupt errors asserted by the agents.

20. The multiprocessor computer system of claim 19 wherein the error notification messages are prioritized as follows from high priority to low priority: fatal, system event, uncorrectable and correctable.
